(19) United States
(12) Patent Application Publication
(10) Pub. No.: US 2024/0316791 A1
(43) Pub. Date: Sep. 26, 2024

(54) PNEUMATIC GRIPPER

(71) Applicant: CAMOZZI AUTOMATION S.P.A., Brescia (IT)

(72) Inventors: Marco ROSSI, Brescia (IT); Fabio LEVI, Brescia (IT)

(21) Appl. No.: 18/574,108

(22) PCT Filed: Jul. 12, 2022
(86) PCT No.: PCT/IB2022/056425

§ 371 Date: Dec. 26, 2023

(30) Foreign Application Priority Data
Jul. 19, 2021 (IT) 102021000019043

(51) Int. Cl. B25J 15/02; B25J 13/08; B25J 15/00; B25J 15/08

(52) U.S. Cl. CPC B25J 15/0293; B25J 13/082; B25J 13/087; B25J 13/088; B25J 15/0023; B25J 15/086

(57) ABSTRACT

A pneumatic gripper is provided which has a shell in which a pneumatic actuation group and an electronic command and control board are housed. The pneumatic actuation group has an internal body in which two pneumatic chambers are formed, a jaw actuation piston being slidably housed in each pneumatic chamber. The internal body houses cartridge solenoid valves suitable to control passage of air from an inlet port to the pneumatic chambers. A transducer shaft is operatively connected to the jaw actuation pistons so as to be actuated to rotate by a translation of the jaw actuation pistons.

The present invention relates to a pneumatic gripper, in particular for robotic applications.

Grippers suitable to grasp and carry an object are well known. Generally, grippers comprise a gripper body and at least two gripper fingers, also called “jaws” in technical jargon, which are movable with respect to the gripper body between an idle open position and a closed position for grasping an object.

In the case of pneumatic grippers, a pneumatic actuation group operatively coupled to the jaws is housed inside the gripper body to move the jaws between the open and closed positions by means of a pressurized command fluid.

In some embodiments, a proportional control of the force and the position of the jaws is desired. The grippers must be equipped with pressure regulators and sensors, which will result in an increased size and weight. Moreover, current grippers, by their very design, do not allow for the level of accuracy and speed of response required, for example, in robotic applications.

It is therefore the object of the present invention to propose a pneumatic gripper that may combine small size and low weight with high performance in terms of controlling the grip on a workpiece.

Another object of the invention is to propose a gripper that, while having a small size and low weight, is able to carry out proportional control of pressure, and thus gripping force, as well as position control with a high level of precision and speed.

Said objects are achieved with a pneumatic gripper according to claim 1.

The dependent claims describe preferred or advantageous embodiments of the gripper.

Further features and the advantages of the pneumatic gripper according to the invention shall be readily apparent from the following description of preferred embodiments thereof, provided purely by way of a non-limiting example, with reference to the accompanying figures, wherein:

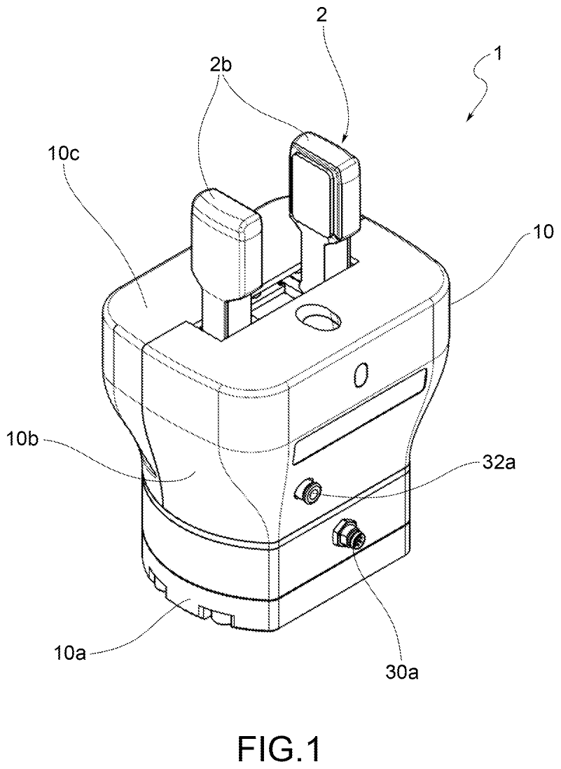

FIG. 1 is a perspective view of a pneumatic gripper;

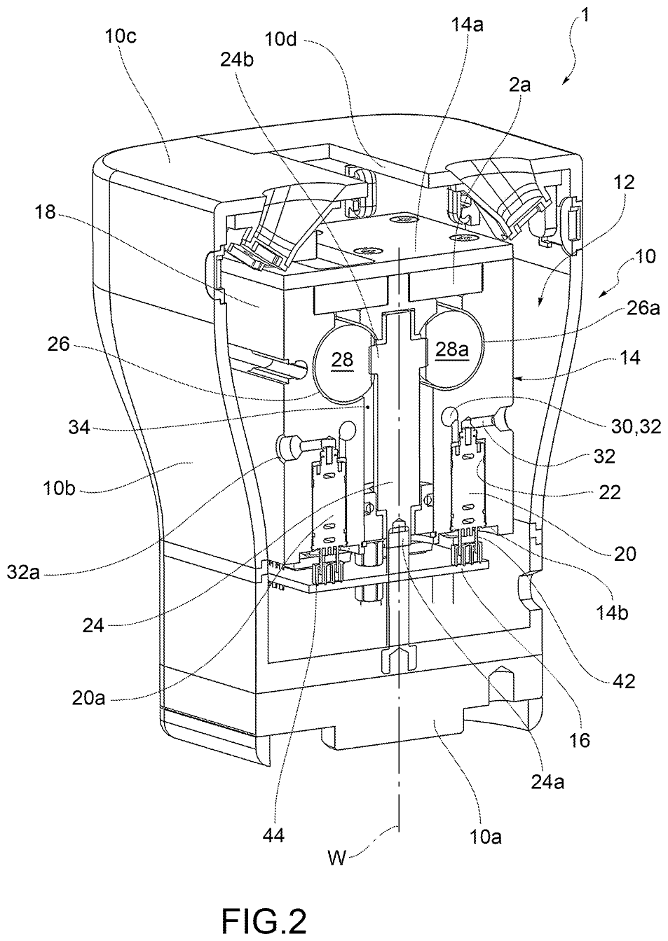

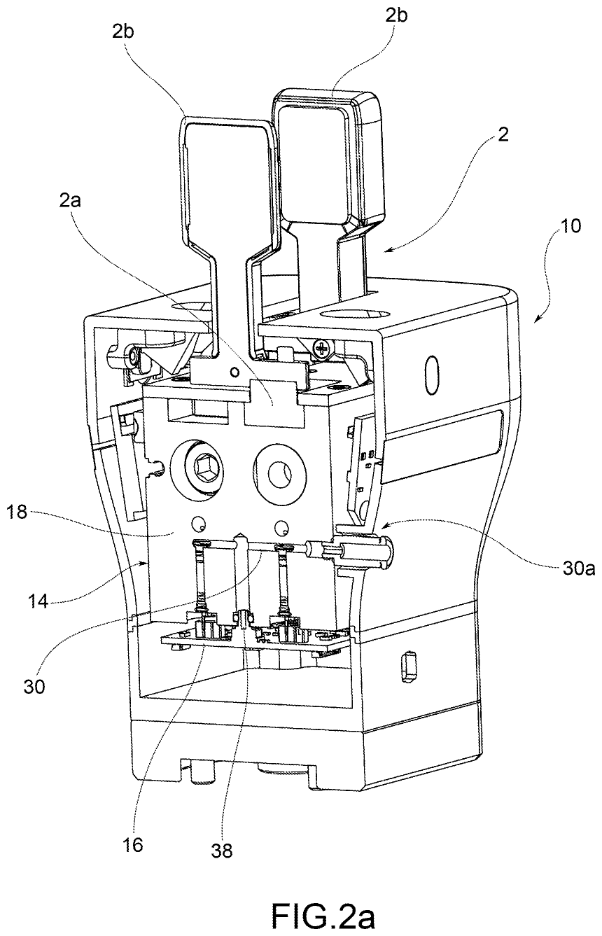

FIG. 2 is an axial section of the gripper in FIG. 1;

FIG. 2a is another vertical section of the gripper in FIG. 1,

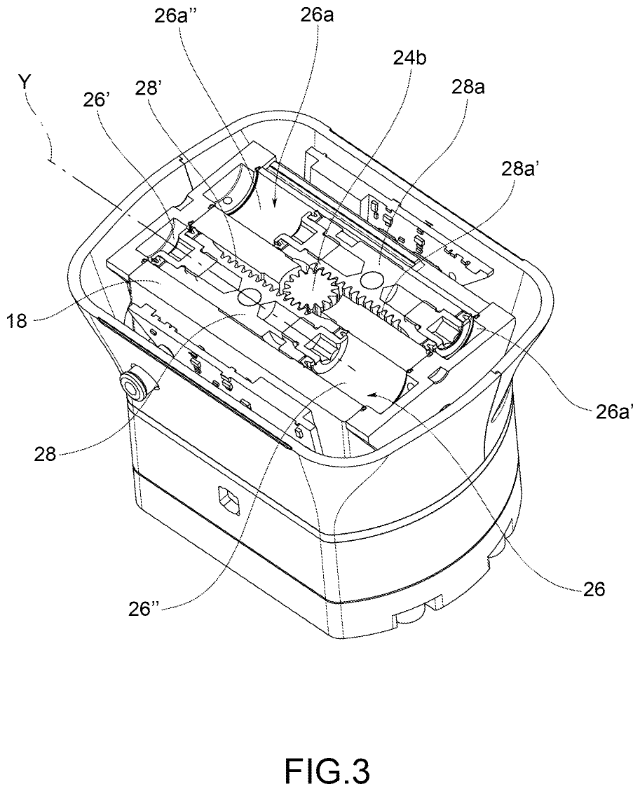

FIG. 3 is a cross section of the gripper in FIG. 1, at the jaw actuation pistons;

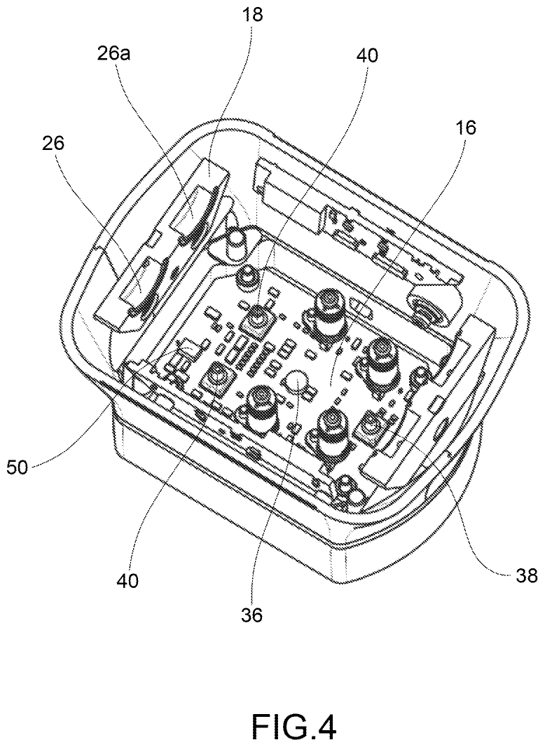

FIG. 4 is a perspective view from above of the inside of the gripper, without the internal body of the pneumatic actuation group;

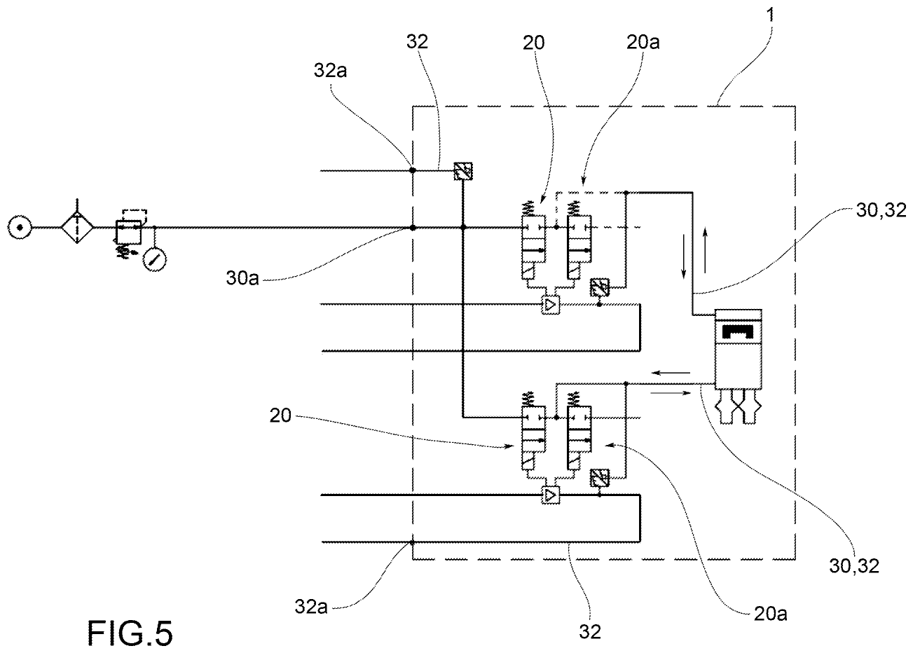

FIG. 5 is a pneumatic diagram of the gripper.

In said drawings, a pneumatic gripper according to the invention has been collectively denoted as 1.

In the remainder of this description, the terms “upper” and “lower” and their synonyms will be used for simplicity of exposition and in a non-limiting manner in reference to the gripper in the position illustrated in the drawings, i.e., with the jaws facing upward and the portion connecting to a robot wrist facing downward.

In a general embodiment, the gripper 1 comprises a shell 10 that defines an internal gripper compartment 12. This internal gripper compartment 12 houses a pneumatic actuation group 14 and an electronic command and control board 16 of the pneumatic actuation group 14.

The gripper 1 is equipped with two gripping jaws 2 commanded by the pneumatic actuation group 14 so as to be translatable along a jaw translation axis (X) between a jaw opening position and a jaw closing position.

In the remainder of the description, the term “gripping jaw” 2 will collectively refer to the movable element formed by a plate-shaped component 2a, or slide, suitable for translating along the translation axis X in a respective guide, and a gripping member 2b, or finger, rigidly connected to, or made in one piece with, the plate-shaped component 2a. The gripping members 2b emerge from the shell 10.

For example, the shell 10 comprises a base 10a, side walls 10b extending from the base 10a, and a top wall 10c that closes the internal gripper compartment 12 at the top and in which one or more slits 10d are obtained, which are penetrated by the gripping members 2b of the jaws 2.

The base 10a may be configured to connect to a robot wrist.

The pneumatic actuation group 14 comprises an internal body 18, cartridge solenoid valves 20, 20a housed in respective valve seats 22 obtained in the internal body 18, and a transducer shaft 24.

In one embodiment, the internal body 18 extends between a distal 14a, or upper, end from which the jaws protrude, and a proximal 14b, or lower, end facing the base 10a of the shell.

For example, the electronic command and control board 16 is placed between the proximal 14b, or lower, end of the internal body 18 and the base 10a of the shell 10.

In an intermediate or upper portion of the internal body 18, two pneumatic chambers 26, 26a extending along respective chamber axes (Y) parallel to each other and to the jaw translation axis (X) are obtained.

A jaw actuation piston 28, 28a is slidingly housed in each pneumatic chamber 26, 26a. Each jaw 2 is rigidly connected to a respective jaw actuation piston 28, 28a.

The two pistons 28, 28a are simultaneously controllable to translate along the chamber axes (Y) in opposite directions to each other, so that the respective jaws 2 are movable towards each other (closing jaws), for gripping a workpiece, or away from each other (opening jaws), for releasing the workpiece.

Each pneumatic chamber 26, 26a is then divided by the respective piston into a closing jaw chamber 26′, 26a′ (i.e., pressurizable to move the pistons together) and an opening jaw chamber 26″, 26a″ (i.e., pressurizable to move the pistons apart).

The pneumatic supply 30 and discharge 32 passages are obtained in the internal body 18. The supply passages 30 put an inlet port 30a, provided with a fitting for connecting to a supply tube, in fluid communication with the valve seats 22, and said valve seats with the jaw closing and opening chambers. Pneumatic discharge passages 32 put the closing and opening jaw chambers in communication with the valve seats 22 and said valve seats with at least one discharge port 32 to discharge air from the chambers, e.g., into the environment.

In one embodiment, the gripper is equipped with four identical cartridge solenoid valves 20, 20a of the 2/2 type (two-way, two-position). Each solenoid valve 20, 20a may then switch between an electrically actuated position, in which it allows the air to flow into or out of the respective chambers, and an idle position, in which it prevents the air from flowing. Therefore, for each of the two pairs of closing jaw 26′, 26a′ and opening jaw 26″, 26a″ chambers, two solenoid valves 20, 20a are used: a supply solenoid valve 20 that controls the passage of air from the inlet port 30a to the respective chambers of the chamber pair; a discharge solenoid valve 20a that controls the passage of air from the respective chambers of the chamber pair to the discharge port 32a.

It should be noted that according to the usual definition of a cartridge valve, a valve seat 22 means not only a cavity that houses the valve, but a cavity that, in cooperation with the cartridge solenoid valve body, forms the supply and discharge chambers in fluid communication with the pneumatic chambers.

In particular, in one embodiment, the valve seats 22 are obtained under, and as close as possible to, the pneumatic chambers 26, 26a, so as to minimize dead volumes and pressure drops and, consequently, have a high response speed to any force and/or pressure change requests.

In one embodiment illustrated in the drawings, the cartridge solenoid valves 20; 20a are arranged to extend predominantly in a vertical direction, i.e., along a valve axis perpendicular to the command and control board 16. Thus, the passages connecting the upper end of each valve seat 22 to the respective pneumatic chamber have a reduced extension.

The electronic command and control board 16 of the pneumatic actuation group 14 is provided with electrical connection means, which are suitable for obtaining an electrical connection with the cartridge solenoid valves 20.

Moreover, on the electronic command and control board 16, a position sensor 36 is mounted, which is operatively coupled to the transducer shaft 24.

Additionally, on the electronic command and control board 16, chamber pressure sensors 40 are mounted, which are suitable for measuring the air pressure in the closing jaw 26′, 26a′ and opening jaw 26″, 26a″ chambers.

In one embodiment, on the command and control board 16, a supply pressure sensor 38 is also mounted, which is in fluid communication with the inlet port 30a to measure the pressure of the air entering the gripper.

In one embodiment, the valve seats 22 are open at the bottom toward the electronic command and control board 16. Each cartridge solenoid valve 20 is equipped with electrical solenoid valve contacts 42, e.g., of the male type, e.g., in the form of pins, extending from the bottom parallel to the shaft axis W, protruding from the internal body 18.

The electronic command and control board 16 supports electrical board connectors 44, e.g., of the female type, which couple electrically with the electrical solenoid valve contacts 42 without requiring connecting cables between the electronic command and control board and the solenoid valves.

The four cartridge solenoid valves 20, 20a, the pressure sensors 38, 40, and the position sensor 36 are operatively connected to a processing unit 50 mounted on the command and control board 16.

In a preferred embodiment, four cartridge solenoid valves 20, 20a are employed so as to implement proportional pressure regulation and consequently, by equipping the jaws with sensor means which are suitable for providing the processing unit 50 with signals indicative of the force exerted by the jaws on the object, as well as of the gripping force. An example of a method for controlling the gripping force of a gripper is described in WO2021084493A1.

This technical solution is particularly advantageous in that it avoids having an actual pressure regulator, which is usually very bulky, and which in the state of the art is not integrated within said device, but rather is positioned externally, for example in the control panel of the robot being used.

For this purpose, the processing unit 50 commands the solenoid valves 20, 20a so as to reach the target pressures, the pressures of the opening and closing chambers being known due to the chamber pressure sensors 40.

In the embodiment that envisages the use of ON/OFF-type cartridge solenoid valves, the solenoid valves are commanded by the processing unit 50 with a PWM modulation.

The transducer shaft 24 extends with the possibility of axial rotation along a shaft axis (W) perpendicular to the chamber axes (Y) in a shaft seat 34 formed in the internal body 18. The transducer shaft 24 is operatively connected to the jaw actuation pistons 28, 28a so as to be actuated to rotate by the translation of the jaw actuation pistons. Therefore, the transducer shaft 24 converts the translatory motion of the pistons into a rotary motion that may be measured, for example, with an encoder.

Note that although the transducer shaft 24 is housed within the pneumatic actuation group 14 so that it is in contact with the actuation pistons, it has no active function in the movement chain of the jaws, but only a passive function of detecting the position of the pistons, and thus the jaws.

In one embodiment, the electronic command and control board 16 is supported by the internal body 18. For example, the electronic command and control board 16 is connected by threaded tie rods 46 to the internal body 18.

Returning now to the transducer shaft 24, in one embodiment the transducer shaft 24 supports, at its lower end facing the command and control board, a magnetic element 24a, such as a magnet.

In this embodiment, the position sensor 36 is an encoder magnetically coupled to the magnetic element. Therefore, it is possible to measure the rotation of the transducer shaft 24 and thus the translation of the actuation pistons without contact between the shaft and the position sensor.

In one embodiment, each actuation piston 28; 28a is equipped on one of its sides facing the other piston with a rack portion 28′, 28a′. The racks are coupled to a central synchronization pinion 24b supported by the transducer shaft 24.

The central synchronization pinion 24b ensures the perfect synchronization between the two movements in opposite directions of the actuation pistons.

Moreover, in addition to carrying out the function of piston synchronization, the center pinion 24b also carries out a self-centering function, i.e., it ensures that the jaws close exactly at the center axis of the gripper.

Overall, this arrangement of the gripper, and in particular the configuration and positioning of the valves and sensors adjacent to the pneumatic chambers, means that the measurement of the pressure in the chambers and the line pressure is very precise, making the response of the device very precise as well.

The presence of an encoder, which reads the position/rotation of the synchronization pinion, enables accurate position control.

The result is a pneumatic gripper that is more compact and lighter than grippers according to the state of the art, which further includes a proportional control of pressure, and thus also of force, and a position control which are very fine in terms of precision and response speed.

Due to the fact that all the devices that implement the command, regulation, and control functions are incorporated into the gripper, the pneumatic and electrical connections of the gripper to external devices are minimized.

A person skilled in the art may make several changes, adjustments and replacements of elements with others that are functionally equivalent to the embodiments of the pneumatic gripper according to the invention in order to meet incidental needs, without departing from the scope of the following claims. Each of the features described as belonging to a possible embodiment may be obtained independently of the other described embodiments.

What is claimed is:

1. A pneumatic gripper, comprising a shell that forms an internal gripper compartment wherein a pneumatic actuation group and an electronic command and control board for commanding and controlling the pneumatic actuation group are housed, two gripping jaws commanded by the pneumatic actuation group so as to be translatable along a jaw translation axis between a jaw opening position and a jaw closing position, wherein the pneumatic actuation group comprises:
an internal body wherein two pneumatic chambers are formed, which extend along respective chamber axes parallel to each other and to the jaw translation axis, a jaw actuation piston being slidably housed in each pneumatic chamber, each pneumatic chamber being divided by the respective jaw actuation piston into a jaw closing chamber and a jaw opening chamber, each gripping jaw being rigidly connected to a respective Law actuation piston;
cartridge solenoid valves housed in respective valve seats formed in the internal body and suitable to control a passage of air from an inlet port to the jaw closing and opening chambers and from the jaw closing and opening chambers to one or more discharge ports;
a transducer shaft that extends with possibility of axial rotation along a shaft axis perpendicular to the chamber axes in a shaft seat provided in the internal body, the transducer shaft being operatively connected to the jaw actuation pistons so as to be rotationally actuated by a translation of the jaw actuation pistons;
and wherein the electronic command and control board is provided with:
electrical connection means suitable to create an electrical connection with the cartridge solenoid valves;
a position sensor operatively coupled to the transducer shaft; and
at least two chamber pressure sensors suitable to measure air pressure in the jaw closing and opening chambers, respectively.

2. The pneumatic gripper of claim 1, wherein the internal body extends between a distal end, from which the gripping jaws extend, and a proximal end from which electrical solenoid valve contacts extending from the cartridge solenoid valves protrude, and wherein the electronic command and control board supports electrical board connectors which electrically couple to the electrical solenoid valve contacts.

3. The pneumatic gripper of claim 1, wherein the electronic command and control board is supported by the internal body.

4. The pneumatic gripper of claim 1, wherein the transducer shaft supports a magnetic element at an end thereof facing the electronic command and control board, and wherein the position sensor is an encoder magnetically coupled to the magnetic element.

5. The pneumatic gripper of claim 1, wherein each jaw actuation piston is provided, on one side thereof facing the other jaw actuation piston, with a rack portion, the rack portions being coupled to a central synchronization pinion supported by the transducer shaft.

6. The pneumatic gripper of claim 1, further comprising a processing unit operatively connected to the cartridge solenoid valves and to the chamber pressure sensors, the processing unit being programmed to command the cartridge solenoid valves so as to carry out a proportional control of the air pressure in the jaw closing and opening chambers, as a function of pressure values detected by the chamber pressure sensors.

7. The pneumatic gripper of claim 6, further comprising sensor means suitable to provide the processing unit (59) with signals indicative of a gripping force applied by the ripping jaws to an item, the processing unit being programmed to implement a gripping force control algorithm based on the signals provided by the sensor means.

8. The pneumatic gripper of claim 6, wherein the cartridge solenoid valves are of the on/off type, and wherein the processing unit is programmed to command the cartridge solenoid valves by a PWM modulation.

9. The pneumatic gripper of claim 1, comprising four identical cartridge solenoid valves of the two-way, two-position type, two supply solenoid valves being used to control the passage of air from the inlet port towards respective jaw closing and opening chambers, two discharge solenoid valves being used to control the passage of air from the respective jaw closing and opening chambers towards the one or more discharge ports.

10. The pneumatic gripper of claim 1, wherein, a supply pressure sensor is mounted to the electronic command and control board in fluid communication with the inlet port to measure pressure of air entering the pneumatic gripper.

11. The pneumatic gripper of claim 6, wherein the position sensor is operatively connected to the processing unit, the processing unit being programmed to implement an algorithm for controlling a position of the gripping jaws based on signals from the position sensor.

12. The pneumatic gripper of claim 6, wherein the processing unit is mounted to the electronic command and control board.
